(19) United States
(12) Patent Application Publication
(10) Pub. No.: US 2004/0157493 A1
(43) Pub. Date: Aug. 12, 2004

(54) Connector arrangement

(76) Inventors: Bert Bergner, Bensheim (DE); Werner Boeck, Gross-Umstadt (DE); Guenter Feldmeier, Lorsch (DE)

Correspondence Address: Barley, Snyder, Senft & Cohen, LLC, 5 Westlakes, Suite 275, 1000 Westlakes Drive, Berwyn, PA, 19312, US

(21) Appl. No.: 10/714,041

(22) Filed: Nov. 14, 2003

(30) Foreign Application Priority Data
Nov. 21, 2002 (EP) 02026332.3

(51) Int. Cl. H01R 9/03

(52) U.S. Cl. 439/610

(57) ABSTRACT

The present invention relates to a connector arrangement having a connector and a corresponding mating connector for electrical connection of at least two multi-core cables, the cables comprising at least two core pairs allowing symmetrical transmission of time-variable differential signals on each core pair, and the connector comprising a connector housing and the mating connector comprising a mating connector housing, each of which comprise contact elements which engage in one another when plugged together. The associated mating contact elements in the connector housing and in the mating connector housing corresponds to the spatial arrangement of the core pairs in the cables. The two core ends and the associated contact elements of each core pair are arranged approximately equidistantly relative to each core end and the associated contact elements of at least one of the other core pairs.

### FIELD OF THE INVENTION

The present invention relates to a connector arrangement for electrical connection of at least two multi-core cables, each cable having at least two core pairs to allow symmetrical transmission of time-variable differential signals on each core pair.

### BACKGROUND OF THE INVENTION

Connector arrangements are used in many areas of technology to connect two cables together electrically. Many requirements are generally imposed on connector arrangements to accommodate the possibilities of using the connectors in a wide range of environments. For example, at high frequencies interference arises in signal transmissions on multi-core cables. The interference may be, for example, electromagnetic interference, cross-talk or cable attenuation. A wide range of different methods are used to counteract these types of interference. To protect against electromagnetic interference, many cables have shielding. Cross-talk may be largely prevented by twisting the cable cores.

The transmission protocol which is selected for signal transmission via multi-core cables often determines which of the various transmission parameters are of particular relevance to the respective application. One of these, as mentioned above, is cross-talk from one channel to an adjacent channel (i.e. from one core pair to another core pair). In ‘star-quad’ cables, a symmetrical construction of the cable is used to provide protection against cross-talk, such that cross-talk attenuation is very high if the core pairs are arranged diagonally.

Compensation of the cross-talk effect in the cables themselves and the corresponding shape of the transmitted signals for suppression of the effect is conventionally achieved by means of twisted-pair cables, in which the conductors are twisted together and thus the mutual influence exerted by the individual cores is suppressed.

Alternatively, so-called star-quad cables, also known as twisted-quad cables, may be used. FIG. 16 shows a cross-section through such a star-quad cable. The cable comprises two core pairs, on which differential signals are transmitted. In the case of signal transmission by means of differential signals, also known as symmetrical signal transmission, the “positive signal” is transmitted on the one core (e.g. 1-1) of a core pair and at the same time the mirror-image “negative signal” is transmitted on the other core (e.g. 1-2). Both signals (i.e. their voltage shapes) have the same amplitude value. In the receiver, the two signals are subtracted from one another, thereby suppressing common-mode interference and amplifying the actual signal. This type of signal transmission is used for many technical applications, such as for example in Ethernet networks, CAN and RS484 systems. The cable is additionally surrounded by a shield 5.

The reason is that the cross-talk interference cancels out is that cores 1-1 and 1-2 are respectively equally spaced from the cores 2-1 and 2-2, and thus the positive signal of core 1-1 cross-talks with the same value on 2-1, for example, as the negative signal on the core 1-2. Thus, the signal cross-talk from the cores 1-1 and 1-2 cancel each other out on cores 2-1 and 2-2.

The above-described arrangement of the core pairs in a star-quad cable thus allows very high cross-talk attenuation to be achieved enabling signal transmission at very high frequencies. It should be noted that many negative influences arising during high-frequency transmission of signals may be solved by an appropriate design of the cable structure.

Connector arrangements which are often used in a transmission link to connect such multi-core cables together constitute points of interference in the transmission link.

One of the most frequent problems which arise in the transmission of signals via cables and thus also when the latter are extended by means of connector arrangements, is electromagnetic interference. In order to achieve good electromagnetic compatibility, therefore, connector and cable are generally provided with shielding, which is intended to reduce these influences. For example, U.S. Pat. Nos. 5,667,407 and 4,702,538 disclose connectors which are externally shielded. In the case of U.S. Pat. No. 5,667,407, conductive components of the connector housing, which are connected to a cable shield, form the shield of the electrical connector.

In order to solve the problem of cross-talk in a connector, individual cores in the connector may be twisted together to reduce cross-talk. Such a connector is disclosed for example in EP 1 206 015 A2. Other arrangements for suppressing the cross-talk effect in connectors are known for example from U.S. application 2001/0021608A1, but this arrangement exhibits the disadvantage of being highly complex.

Multi-pole connector arrangements for connecting such multi-core cables are disclosed, for example, in EP 0 809 331 B1, which uses a multi-pole plug system with a socket and at least one plug for electrical and mechanical connection of electrical conductors in a building cabling network. By feeding a plurality of cables with individual core pairs to a socket, it is possible to tap one or more services from a socket as described.

Moreover, it is known in the art to supply terminals in Ethernet cable networks with direct current via the cores of an Ethernet cable. This technology is often known as Power-over-Ethernet. Documents U.S. Pat. No. 6,295,356 B1 and JP-2000134228A show examples of this application.

As mentioned above, connector arrangements which connect together the star-quad cables or other high-frequency cables constitute points of interference within transmission links, by which the transmission parameters are impaired. The known solutions which are intended to solve the problem, for example, of cross-talk in a connector are generally inadequate or can only be achieved with high material consumption and at high financial cost.

It is therefore the object of the present invention to provide a connector arrangement and an associated assembly method which exhibit improved transmission parameters and in particular reduce cross-talk to a minimum and moreover are economic to produce with regard to both cost and materials.

### SUMMARY OF THE INVENTION

The present invention is based on the discovery that the advantageous arrangement of cores in cables, in particular in star-quad cables, may also be used advantageously in a connector arrangement due to its good transmission parameters.

In order to optimise the transmission parameters of the connector arrangement, an exemplary connector arrangement according to the invention has a spatial arrangement of the core ends and the associated mating contact elements in the connector housing and in the mating connector housing configured to correspond to the spatial arrangement of the core pairs in the cables and the two core ends and the associated contact elements of each core pair are arranged approximately equidistant relative to each core end and the associated contact elements of at least one of the other core pairs.

By retaining the spatial arrangement of the core ends and the associated contact elements in the connector housing and in the mating connector housing, the physical properties in the connector arrangement (i.e. the transmission parameters) may advantageously be influenced. In particular, an arrangement of the core ends and the associated contact elements in the connector housing or in the mating connector housing that maintain the spatial arrangement of the core pairs in the cables leads to particularly good cross-talk attenuation.

To optimise this exemplary connector arrangement further and to prevent electromagnetic interference, the connector and the mating connector comprise shields, the shape of which is conformed to the connector or mating connector, respectively.

Further optimisation of the transmission parameters of the connector arrangement may be achieved in that the shield of the connector may be connected to the shield of the mating connector by plugging together.

If the cables to be connected are star-quad cables, it is particularly advantageous for the individual cores formed by the contact element in the connector arrangement to lie approximately on a circular path. Thus, the arrangement of the cores in the connector arrangement matches that in the cable. Accordingly, the good transmission parameters achievable with the star-quad cable may be substantially retained even at the connector arrangement.

In accordance with the spatial arrangement of the cores in the connector, the connector comprises a connector face in which the contact elements are appropriately arranged.

In particular, retention of the symmetrical arrangement, i.e. the spatial arrangement of the cores in the connector, allows the production of particularly small circular connectors, which for example comprise an M12 plug face. The construction according to the invention of these circular connectors allows particularly good transmission parameters to be achieved when using circular connectors up to a signal frequency range of several hundred MHz.

The connector arrangement according to the invention may advantageously be used in Power-over-Ethernet systems, by transmitting a direct current on two cores in addition to the differential signals.

Tests and measurements have shown that even shields in the connector and in the mating connector which exhibit slight asymmetry allow good transmission parameters in the transmission link.

To be able to connect connector and mating connector together in a mechanically stable and loadable manner, it is advantageous for the shields of the connector and of the mating connector to be capable of being screwed or latched together, thereby achieving continuous shielding of the transmission link.

The small number of individual components of a connector according to the present invention makes it possible to achieve simple, cost-effective assembly of a connector.

During this process, the individual cores of the cable are connected with contact elements of the connector and these contact elements are introduced into an insulated connector housing, such that, by introducing the contact elements into the connector housing, the spatial arrangement of the core pairs in the connector housing retains the spatial arrangement in the cable and the two cores of each core pair are arranged approximately equidistantly relative to each core of at least one of the other core pairs.

To prevent unintentional detachment of the contact elements from the insulated connector housing, for example by the action of mechanical forces, it is advantageous for the connector housing to comprise a contact securing means and for the contact securing means to be closed during assembly of the connector prior to the fitting of shield plates, fixing the contact elements in the connector housing.

Furthermore, the connector arrangement is designed in such a way that the mating connector may also be connected to a printed circuit board and printed circuit boards and cables may thus advantageously be connected using transmission properties of a connector arrangement according to the invention.

### BRIEF DESCRIPTION OF THE DRAWINGS

The invention is explained more fully below with reference to the preferred embodiments illustrated in the attached drawings. Similar or corresponding details are provided with identical reference numerals in the Figures. In the Figures:

FIG. 1 is a sectional view of a connector arrangement according to an exemplary embodiment of the invention, with a connector and a mating connector,

FIG. 2 is a plan view of the plug face of the connector of FIG. 1,

FIG. 3 is a schematic representation of a section through a connector of a connector arrangement according to an exemplary embodiment of the invention with a circular cross-section,

FIG. 4 is a schematic representation of a section through a connector of a connector arrangement according to a second exemplary embodiment of the invention with a substantially rectangular cross-section,

FIG. 5 shows a four-core cable with contact elements prior to introduction of the contact elements into a connector housing of a connector arrangement according to the second exemplary embodiment of the invention,

FIG. 6 shows the four-core cable with contact elements of FIG. 5 after introduction of the contact elements into the connector housing,

FIG. 7 shows the four-core cable with contact elements of FIGS. 5 and 6 after introduction of the contact elements into the connector housing, with closed contact securing means,

FIG. 8 shows the four-core cable with contact elements of FIGS. 5, 6, and 7 introduced into the connector housing and shield plates, prior to fitting of the shield plates,

FIG. 9 shows the four-core cable with contact elements of FIGS. 5, 6, 7, and 8 introduced into the connector housing and shield plates, after fitting of the shield plates,

FIG. 10 shows the four-core cable with contact elements of FIGS. 5, 6, 7, 8, and 9 with the cable shield contacting the shield plates, and positioning of a crimp barrel,

FIG. 11 shows the four-core cable with contact elements of FIGS. 5, 6, 7, 8, 9, and 10 with the crimp barrel fastened via the contact zone of the shield plates and the cable shield,

FIG. 12 shows the four-core cable with contact elements of FIGS. 5, 6, 7, 8, 9, 10, and 11 with the connector mated to a corresponding mating connector,

FIG. 13 shows a plug face of a connector according to the second embodiment of the invention,

FIG. 14 is a circuit diagram for supplying direct current to a transmission system,

FIG. 15 shows a mating connector coupled to a printed circuit board, and

FIG. 16 shows a schematic cross-section through a star-quad cable.

### DETAILED DESCRIPTION OF THE INVENTION

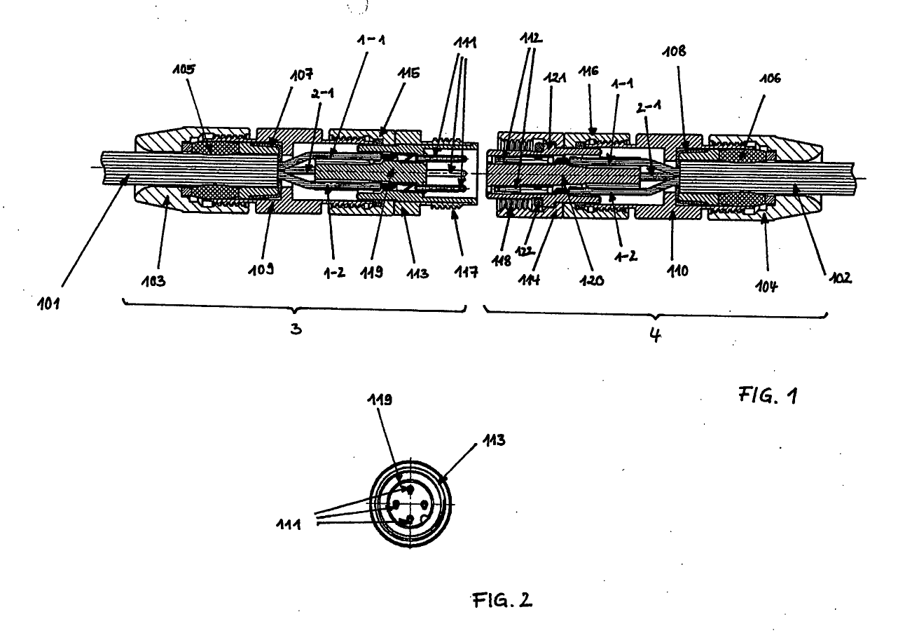

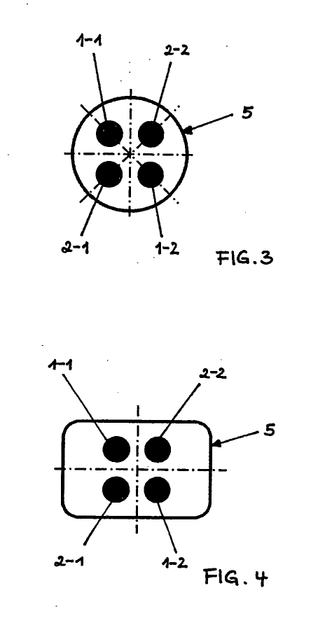

FIG. 1 shows a connector arrangement according to the invention in a first embodiment with a connector 3 and a corresponding mating connector 4. A cable 101, a star-quad cable in the embodiment illustrated, has been bared at its end, such that the cable shield 107 and the cable cores 1-1, 1-2, 2-1 and 2-2 (shown in FIGS. 3 and 4) project out of the cable end. The bared end of the star-quad cable 101 has been inserted into a first shielding part 109 of the connector housing. The first shielding part 109 has on its side facing the cable a seal 105, which protects the inside of the connector housing from the penetration of liquids and dirt. The cable shield 107 has been bent round in such a way that it contacts the first shielding part 109 of the connector.

In order to fix the cable 101 in the first shielding part 109 of the connector, a screw-down nut 103 is provided. This is screwed to the first shielding part 109 of the connector housing. To this end, threading is provided at the appropriate points on the screw-down nut 103 and the first shielding part 109 of the connector housing.

The bared ends of the cores 1-1, 1-2, 2-1 and 2-2 end in a contact zone 119, which connects the bared ends of the cores 1-1, 1-2, 2-1 and 2-2 with contact pins 111. The contact zone 119 is so designed that the spatial arrangement of the individual cores 1-1, 1-2, 2-1 and 2-2 of the cable 101 is retained in the connector 3 (i.e. the spatial arrangement of the core ends and the associated mating contact elements (contact pins 111) in the connector housing corresponds to the spatial arrangement of the core pairs 1-1, 1-2, 2-1 and 2-2 in the cable 101). Furthermore, the two core ends and the associated contact elements (contact pins 111) of each core pair (e.g. core pair 1-1, 1-2) are arranged approximately equidistantly relative to each core end and the associated contact element (contact pins 111) of at least one of the other core pairs (e.g. core pair 2-1, 2-2).

The contact zone 119 is surrounded in sealing manner by a second shielding part 115 of the connector housing and a third shielding part 113 of the connector housing. The second shielding part 115 of the connector housing may be screwed to the first shielding part 109 of the connector housing. In addition, the second shielding part comprises a seal which seals the connection between first shielding part 109 and second shielding part 115 of the connector housing.

Together with the contact pins 111 and the contact zone 119, the third shielding part 113 of the connector housing forms the plug face of the connector, as illustrated in FIG. 2. The third shielding part 113 of the connector housing comprises a thread 117 on its outside, the function of which will be explained more fully below.

Through the contact between the individual shielding parts 109, 113 and 115, a continuous shield is formed in the connector housing which extends from the outlet point of the cores 1-1, 1-2, 2-1 and 2-2 out of the cable shield of the cable 101 as far as the end of the contact pins facing the mating connector 4. This shield is additionally connected to the cable shield 107, such that the latter is continued in the connector 3.

The individual components of the mating connector 4, which is likewise illustrated in FIG. 1, correspond substantially to those of the connector 3 and fulfil the same functions.

A second cable 102 (a star-quad cable in the illustration) is introduced into the mating connector 4 at the opposite end from the mating connector face. In the connector 3, the cores of the cable 102 are connected by the connector arrangement according to the invention substantially corresponding to those of the cable 101.

The cable 102 of the mating connector also has a shield 108 and, in the exemplary embodiment illustrated, four cores 1-1, 1-2, 2-1 and 2-2. The bared ends of the cores 1-1, 1-2, 2-1 and 2-2 are connected in a contact zone 120 of the mating connector 4 to contact sockets 112, in which the plug pins 111 of the connector engage upon plugging the connector and the mating connector together, thereby connecting together the cores 1-1, 1-2, 2-1 and 2-2 of the two cables 101, 102 in an electrically conductive manner.

The contact zone 120 in the mating connector 4 is also designed in such a way that the spatial arrangement of the cores 1-1, 1-2, 2-1 and 2-2 corresponds approximately to that in the cable 102. The contact zone 120 is so designed that the spatial arrangement of the individual cores 1-1, 1-2, 2-1 and 2-2 of the cable 102 is retained in the mating connector 4, i.e. the spatial arrangement of the core ends and the associated mating contact elements (contact sockets 112) in the connector housing corresponds to the spatial arrangement of the core pairs 1-1, 1-2, 2-1 and 2-2 in the cable 101. Furthermore, the two core ends and the associated contact elements (contact sockets 112) of each core pair (e.g. core pair 1-1, 1-2) are arranged approximately equidistantly relative to each core end and the associated contact element (contact sockets 112) of at least one of the other core pairs (e.g. core pair 2-1, 2-2).

As in the connector 3, the cable shield 108 of the cable 102 is connected conductively to a shield which extends along the longitudinal axis of the connector as far as the end of the mating connector, in which the connector 3 engages.

The shield is formed by three shielded parts 110, 114 and 116, which are connected together as in the connector 3. At its end facing the cable 102, the mating connector 4 comprises a screw-down nut 104, which may be screwed to a first shielding part 110 of the mating connector housing. By screwing the screw-down nut 104 to the first shielded part 110 of the mating connector housing, the cable 102 is sealed by a seal 106 relative to the inside of the mating connector. The penetration of gas, liquids and dirt is thereby prevented.

At its opposite end from the cable 102, the mating connector 4 comprises a plug face, such that the connector 3 may be fitted together with the mating connector 4. At its end in which the connector 3 engages, the mating connector 4 also comprises a thread 118 which may be screwed together with the thread 117 of the connector 3.

By screwing together the third shielding part 113 of the connector 3 and the third shielding part 114 of the mating connector 4, the contact pins 111 engage in the corresponding contact sockets 112 and thus produce an electrical connection between the cables 101 and 102.

In addition, the screw connection makes possible mechanically stable coupling of the two components (connector 3 and mating connector 4) of the connector arrangement.

So that it is possible to screw the connector 3 and the mating connector 4 together without twisting the cable, the third shielding part 114 of the mating connector housing is connected to the contact zone 120 in such a way that it may rotate about the longitudinal axis of the mating connector 4. To this end, a projection 121 is formed on the contact zone 120, which projection 121 ensures that the third shielding part 114 of the mating connector housing is held together and at the same time allows rotation thereof. In this way, the two third shielding parts 113 and 114 may be screwed together without any need for twisting of the cables 102, 103.

To protect the connection between connector and mating connector against gases, liquids and dirt, the mating connector 4 comprises a sealing ring 122, which ensures sealing of the connection between connector 3 and mating connector 4 when the third shielding parts 113 and 114 are screwed together.

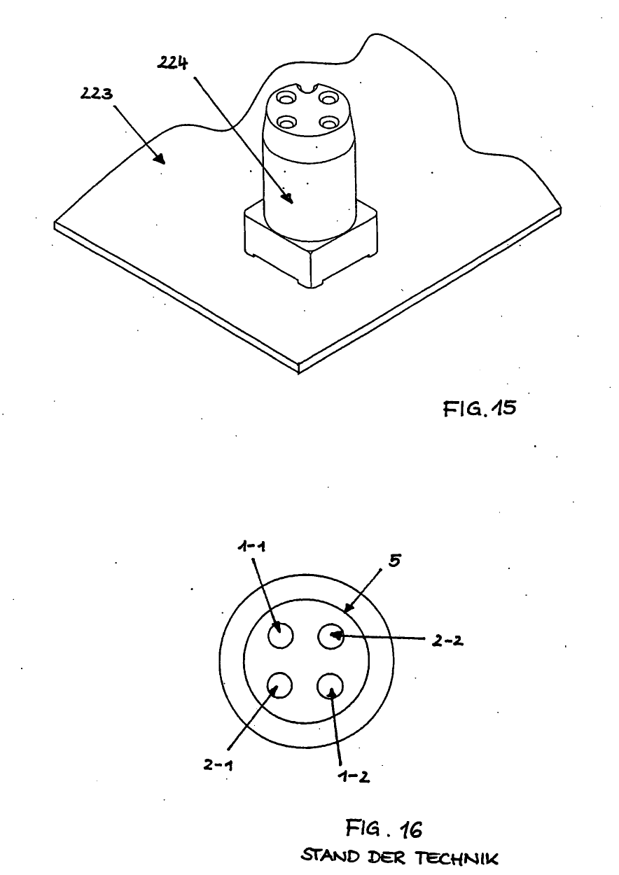

FIG. 2 is a view of the connector face of the connector 3 of FIG. 1. In the illustrated embodiment, the connector is a circuit connector, here for example of the size M12. The contact pins 111 of the connector 3 are arranged in such a way that their spatial arrangement matches that of the cable 101. A comparison with the schematic cross-section shown in FIG. 16 of a star-quad cable shows that the symmetrical arrangement of the cores 1-1, 1-2, 2-1 and 2-2 of the cable 101, which lie approximately on a circular path, matches the core arrangement in the connector 3 itself.

In the first embodiment of a connector arrangement according to the invention, illustrated in FIG. 1 and FIG. 2, as a result of the spatial arrangement of the cores 1-1, 1-2, 2-1 and 2-2 and the shield, the physical properties in the connector 3 and the mating connector 4 substantially match those in the cables 101, 102. In this way it is possible, as in the cables, to configure the transmission parameters in a transmission line, despite the provision of a connector arrangement, such that they are optimised (i.e. good shielding is provided against electromagnetic waves, and low levels of cross-talk occur between the individual cores 1-1, 1-2, 2-1 and 2-2 of the cables 101, 102).

FIGS. 3 and 4 are schematic representations of the symmetry conditions with circular and rectangular connector cross-sections, which make it possible to achieve improved transmission parameters despite the use of connector arrangements in a star-quad transmission link.

FIG. 3 shows the arrangement which is used in the first embodiment of the connector arrangement shown in FIGS. 1 and 2. As is clear from a comparison with FIG. 16, the positioning of the shield 5 and of the cores 1-1, 1-2, 2-1 and 2-2 matches that in the star-quad cable. Axes of symmetry of the arrangement are drawn in FIGS. 3 and 4 with broken lines. This symmetrical arrangement allows cross-talk attenuation of the signals transmitted on the cores 1-1, 1-2, 2-1 and 2-2 to be reduced, as in a cable with a matching core arrangement.

Tests and measurements have shown that slight deviations in the symmetry of the shield relative to that in the cable, as illustrated in FIG. 4, do not result in any noteworthy deterioration in the transmission parameters of the connector arrangement. In FIG. 4, the shield 5 is shown to be substantially rectangular and thereby deviates from the circular shield in the star-quad cable. The arrangement of the cores 1-1, 1-2, 2-1 and 2-2 matches that in the star-quad cable. The illustrated slight asymmetry of the shield 5 does not have a significant effect on the cross-talk values, if symmetry is retained in the arrangement of the cores 1-1, 1-2, 2-1 and 2-2.

A method is described below, with reference to FIGS. 5 to 13, for assembling a connector according to the invention in a second embodiment, the cross-section of which matches that shown in FIG. 4.

In a first step, as illustrated in FIG. 5, the cores 15 of a cable 8 are connected to contact elements 6. The cable 8 has a shield 7 of wire mesh. The connector housing 12 comprises two contact securing means 9.

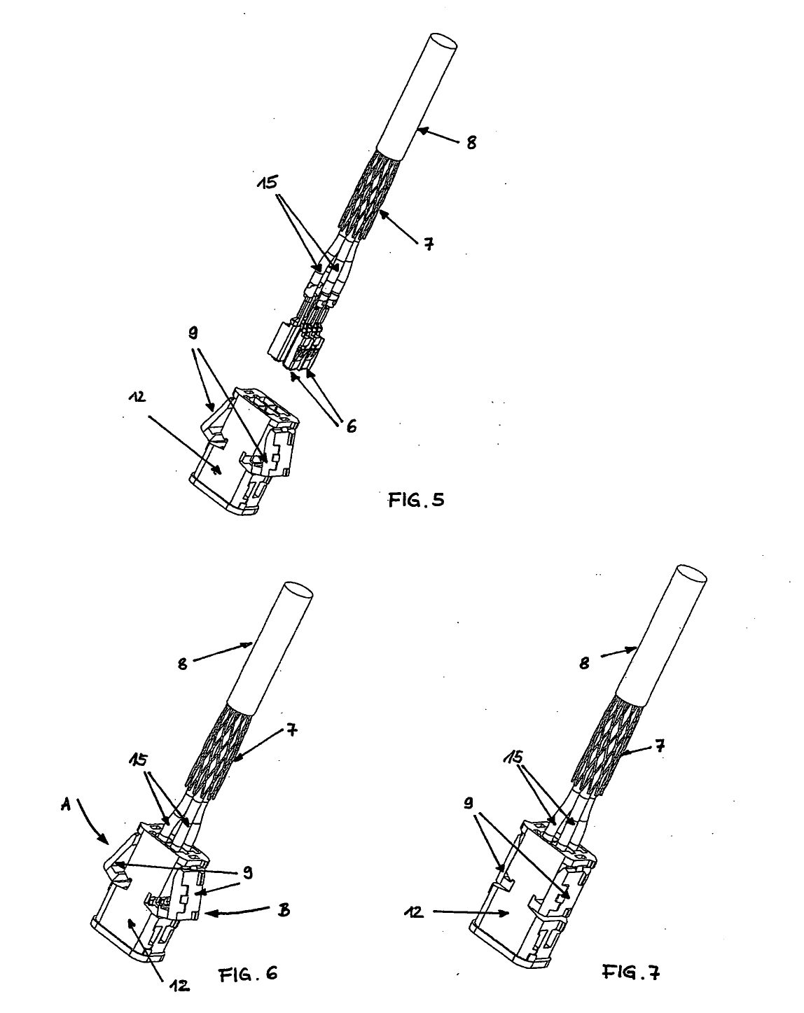

Next, as shown in FIG. 6, the contact elements 6, and the cores 15 of the cable 8 connected thereto, are introduced into the connector housing 12 and the contact securing means 9 are closed, as indicated by the two arrows designated A and B.

FIG. 7 shows the connector 3 after introduction of the contact elements 6 into the connector housing 12 and after closure of the contact securing means 9. The contact securing means 9 prevent the contact elements 6 from slipping out of the connector housing 12 (i.e., the contact elements are fixed in the connector housing). The contact elements 6 may be removed from the connector housing by opening the contact securing means 9.

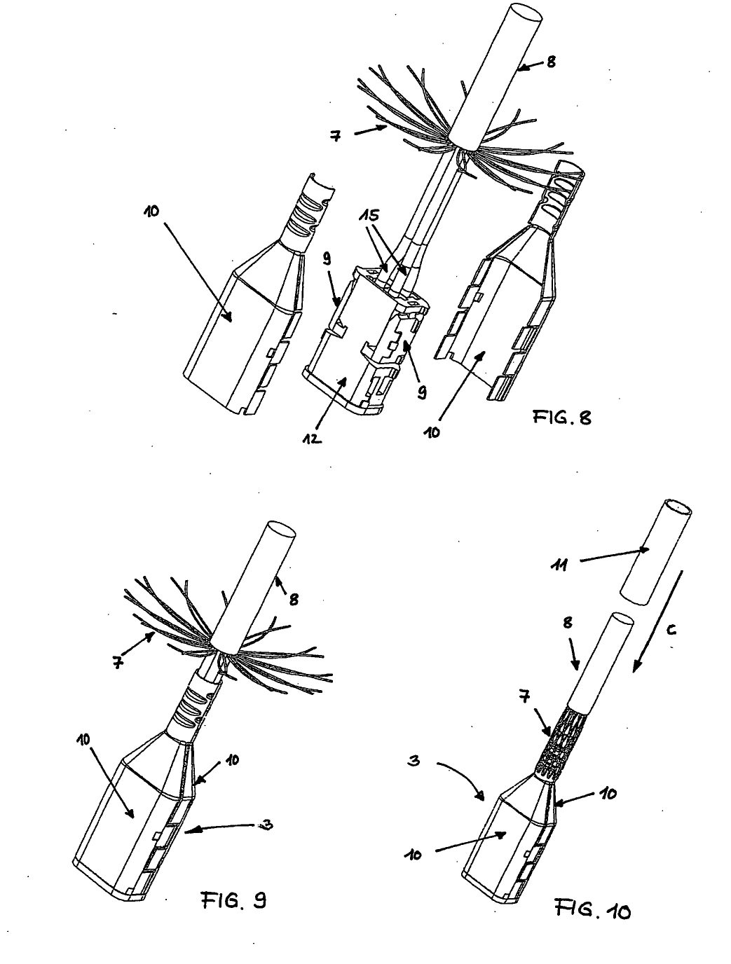

After introduction of the contact elements 6 into the insulating connector housing 12, the shield 7 of the cable 8 is bent backwards, as shown in FIG. 8, such that shield plates 10 may be fitted such that they surround the connector housing 12 in shielding manner. The fitted shield plates 10 then enclose the connector housing 12, as shown in FIG. 9.

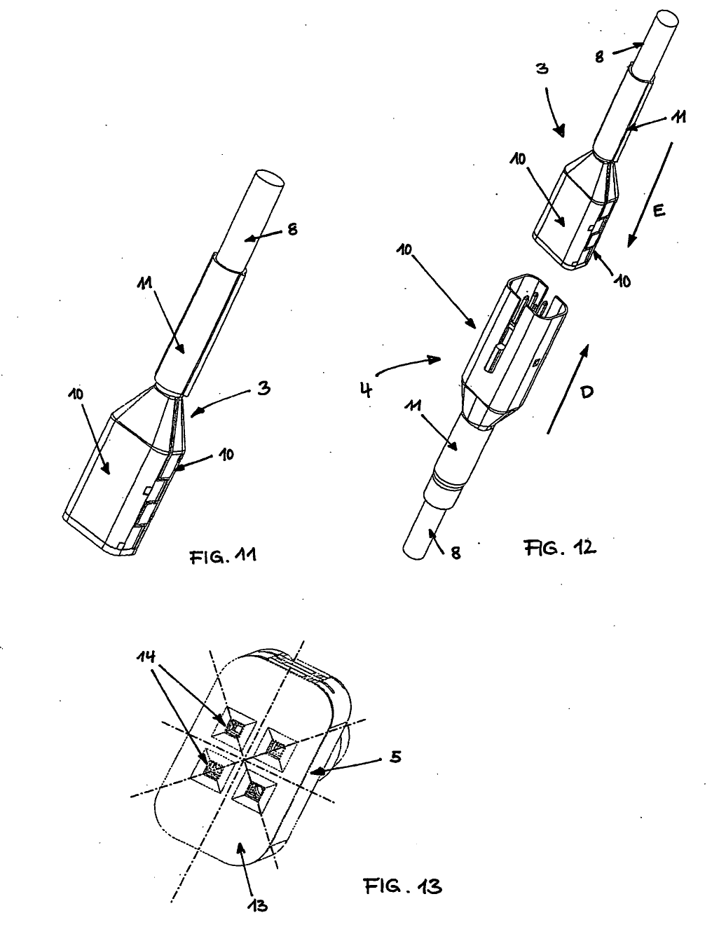

The cable shield 7 may then be connected to the shield plates 10, as shown in FIG. 10. To achieve additional mechanical stabilisation of the connection between the cable shield 7 and the shield plates 10, a crimp barrel 11, which has been pushed onto the cable 8 prior to assembly, is then displaced along the cable 8 over the contact zone between cable shield 7 and the shield plates 10 in the direction indicated by arrow C and is positioned and attached over the contact zone of the cable shield 7 and the shield plates 10.

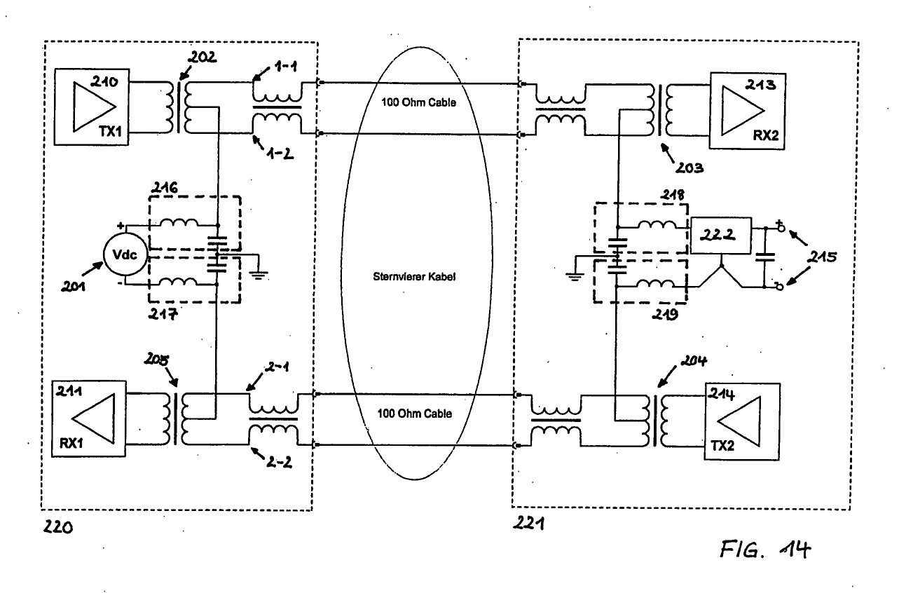

FIG. 11 shows a ready-assembled connector 3 according to the second embodiment. In the embodiment shown, the shield plates 10 form the external housing 12 of the connector. FIG. 12 shows, indicated by arrows D and E, fitting together of the connector 3 according to the second embodiment with a corresponding mating connector 4.

FIG. 13 shows the connector face 13 of the connector 3 according to the second embodiment. Arranged in the center of the connector face 13 are four contact sockets 14, into which engage contact pins of a corresponding mating connector 4, as shown in FIG. 12, upon plugging the connector and the mating connector together. Broken lines are again used to show the axes of symmetry of the arrangement of the contact sockets 14. Slight asymmetry of the shield 5 is visible at the edge of the connector face 13.

FIG. 14 shows a schematic representation of a circuit which allows power to be supplied to terminals via a star-quad cable. This technology, also known as Power-over Ethernet, is particularly well suited to Ethernet applications (e.g., 10 Base-T, 100 Base-T). Adaptation of the receiving 221 and transmitting 220 sides of the circuit to the 100? cable impedance is not shown, for the purposes of simplification.

In the Figure, the devices 220, 221 each comprise a transmitter 210, 214 and a receiving station 211, 213. In a transmitting apparatus 220 there is provided a direct voltage source 201, which, via the LC elements 216, 217, conveys a direct voltage V_{dc} to couplers 202, 205, on to the cores 1-1, 1-2, 2-1 and 2-2 of the star-quad cable and to a second terminal 221.

In the process, the signals pass over a transmission line, whose impedance is assumed to be 100?, for example. In the terminal 221 receiving the direct voltage, the transmitted direct voltage is decoupled via the couplers 203 and 204 and may be tapped off at the voltage tapping contacts 215, after the decoupled voltage has been routed through the LC elements 218 and 219 and to a voltage regulator 222. Voltage tapping terminals 221 may also be active star couplers, such as switches or hubs. The advantage of this protective circuit as shown is that the good high-frequency transmission characteristics are not impaired by the direct current transmission as a result of the above-described symmetry conditions in the star-quad cable and in the connector arrangements.

The current-carrying windings of the transformers 202, 203, 204, 205 must be dimensioned to match the respective current loading. The LC elements 216 to 219 have to be so dimensioned that the frequency bands for high-frequency signal transmission and power supply are clearly separated from one another. For example, in CAT5 applications, the signal transmission band is fixed at 1 to 100 MHz. On the power supply side 220, harmonics extending into the lower megahertz range are wholly possible, especially when switching controllers and processors are used. Adequate decoupling must, therefore, be ensured.

The protective circuit illustrated may also be used, independently of the use of a star-quad cable, for twisted pair lines, provided that at least two pairs of lines are available.

The utilisation of cable symmetry characteristics may also be exploited for coupling such cables to printed circuit boards. In FIG. 15, for example, a mating connector 224 is coupled directly to a printed circuit board 223, such that signals may be transmitted directly and with low interference from printed circuit boards 223 into a cable and vice versa.

What is claimed is:

1. A connector arrangement for electrically connecting multi-core cables to each other, the cables having at least two core pairs allowing symmetrical transmission of time-variable differential signals on each core pair, the connector arrangement comprising:
a connector and a mating connector each having a housing; and,
contact elements being connected to core ends of the core pairs and being arranged in each housing to correspond to the spatial arrangement of the core pairs in the cables such that each core pair is arranged approximately equidistantly relative to each core end and the associated contact elements of at least one of the other core pairs.

2. A connector arrangement according to claim 1, wherein the connector and the mating connector comprise shields, the shape of which is conformed to the connector or the mating connector respectively.

3. A connector arrangement according to claim 2, wherein the shield of the connector is electrically connected to the shield of the mating connector upon plugging together.

4. A connector arrangement according to claim 1, wherein the cables are star-quad cables and the individual cores pass through the connector arrangement approximately on a circular path therein.

5. A connector arrangement according to claim 1, wherein the connector and mating connector comprise a plug face, in which the contact elements are arranged in accordance with the spatial arrangement of the core ends in the connector and in the mating connector.

6. A connector arrangement according to claim 5, wherein the connector is a circular connector, which comprises an M12 plug face.

7. A connector arrangement according to claim 1, wherein the cables, connector and mating connector are configured to carry a direct current transmitted on two cores in addition to the differential signals.

8. A connector arrangement according to claim 2, wherein the shield of the connector and the shield of the mating connector are asymmetrical.

9. A connector arrangement according to claim 1, wherein the connector and the mating connector may be screwed or latched together.

10. A connector arrangement according to claim 1, wherein the mating connector is configured for connection to a printed circuit board.

11. A method of assembling a connector for electrical connection of at least two cables, the cables each comprising at least two core pairs allowing symmetrical transmission of time-variable differential signals on each core pair, the method comprising the steps of:
connecting ends of the cores of the cable to contact elements of the connector,
introducing the contact elements into an insulating connector housing such that the two core ends and the associated contact elements of each core pair are arranged approximately equidistantly relative to each core end and the associated contact elements of at least one of the other core pairs,
fitting shield plates to enclose the connector housing,
connecting the shield plates to a cable shield, and
positioning and attaching a crimp barrel on the area of the shield plate ends which contacts the cable shield.

12. A method of assembling a connector according to claim 11, wherein the connector housing comprises a contact securing means and the method further comprises the following step prior to fitting of the shield plates:
closing the contact securing means to fix the contact elements in the connector housing.
